(19) United States
(12) Patent Application Publication
(10) Pub. No.: US 2025/0323743 A1
(43) Pub. Date: Oct. 16, 2025

(54) Scheduled synchronization messages

(71) Applicant: MELLANOX TECHNOLOGIES, LTD., Yokneam (IL)

(72) Inventors: Natan Manevich, Nesher (IL); Dotan David Levi, Kiryat Motzkin (IL); Nir Laufer, Zoran (IL); Wojciech Wasko, Mlynek (PL); Maciej Machnikowski, Reda (PL); Bar Shapira, Tel Aviv (IL); Ariel Almog, Kochav Yair (IL)

(21) Appl. No.: 18/631,095

(22) Filed: Apr. 10, 2024

(51) Int. Cl. H04J 3/06

(52) U.S. Cl. CPC H04J 3/0667

(57) ABSTRACT

In one embodiments, a system includes a network device including a host interface to receive time synchronization messages generated by software executed by a processing unit of a host device, a hardware clock to maintain a clock time, scheduler circuitry to manage periodic transmission of the time synchronization messages according to the clock time and schedule data provided by the software, and a network interface to transmit the time synchronization messages to at least one clock synchronization follower according to the schedule data and the clock time.

### FIELD OF THE DISCLOSURE

The present disclosure relates to computer systems, in particular, but not exclusively to, clock synchronization.

### BACKGROUND

Clock synchronization among network devices is used in many network applications. One application of using a synchronized clock value is for measuring one-way latency from one device to another device. If the clocks are not synchronized the resulting one-way latency measurement will be inaccurate. Synchronization is typically achieved by syntonization, in which the clock frequency of two devices is aligned, and aligning the phase between the two devices.

For Ethernet, there are two complementary methods to achieve synchronization. One is Synchronous Ethernet (SyncE), which is a physical-layer protocol which achieves syntonization based on the receive/transmit symbol rate. SyncE is an International Telecommunication Union Telecommunication (ITU-T) Standardization Sector standard for computer networking that facilitates the transference of clock signals over the Ethernet physical layer. In particular, SyncE enables clock syntonization inside a network with respect to a leader clock.

The other is Precision Time Protocol (PTP), which is a packet-based protocol that may be used with SyncE to align offset (e.g., in Coordinated Universal Time (UTC) format) and phase between two clocks. PTP is used to accurately synchronize clocks throughout a computer network, and is considered to be the de facto standard for this purpose. PTP is an example of a two-way time synchronization protocol. A two-way time synchronization protocol uses time synchronization packets which are exchanged in both directions between a clock leader and a clock follower.

In PTP, the clock synchronization leader (the “leader”) wakes up and starts a synchronization handshake periodically. The handshake includes the leader sending a sync message at time T1 that is received by the clock synchronization follower (the “follower”) at time T2. The leader sends a follow up message with T1 inside the follow up message. The follower sends a delay request message at time T3, which is received by the leader at time T4. The leader in response sends a delay response message with T4 inside the delay response message. Therefore, the follower has times T1-T4 which are all the times needed to compute a time adjustment according to PTP. The follower computes the adjustment based on the values T1 to T4 and the time that the follower expects the next sync message to arrive. For example, the follower may make the adjustment so that the time of the follower will be the same as the leader (assuming the leader and follower do not drift anymore) next time a sync message is received. IEEE specifies an acceptable error rate (e.g., up to 30%) with respect to a known gap between consecutive sync messages.

### SUMMARY

There is provided in accordance with an embodiment of the present disclosure, a system including a network device, the network device including a host interface to receive time synchronization messages generated by software executed by a processing unit of a host device, a hardware clock to maintain a clock time, scheduler circuitry to manage periodic transmission of the time synchronization messages the clock time and schedule data provided by the software, and a network interface to transmit the time synchronization messages to at least one clock synchronization follower the schedule data and the clock time.

Further in accordance with an embodiment of the present disclosure the scheduler circuitry is to manage the periodic transmission of the time synchronization messages a transmission time of a first one of the time synchronization messages provided by the software and a given periodic time or frequency provided by the software.

Still further in accordance with an embodiment of the present disclosure the time synchronization messages are sync messages Precision Time Protocol (PTP).

Additionally in accordance with an embodiment of the present disclosure the scheduler circuitry is to manage transmission of each of the time synchronization messages a scheduled transmission time assigned by the software for each of the time synchronization messages.

Moreover in accordance with an embodiment of the present disclosure, the system includes the host device including the processing unit to execute the software to generate the time synchronization messages and associated work descriptors having corresponding transmission times at which the time synchronization packets are to be transmitted to the at least one clock synchronization follower, wherein the scheduler circuitry is to manage the periodic transmission of the time synchronization messages the corresponding transmission times of the associated work descriptors and the clock time of the hardware clock.

Further in accordance with an embodiment of the present disclosure the scheduler circuitry is to manage the periodic transmission of the time synchronization messages a given periodic time or frequency provided by the software.

Still further in accordance with an embodiment of the present disclosure, the system includes the host device including the processing unit to execute the software to generate the time synchronization messages and associated work descriptors, add the work descriptors to a work queue designated for transmitting the time synchronization messages, and provide the given periodic time or frequency to the scheduling circuitry.

Additionally in accordance with an embodiment of the present disclosure the time synchronization messages are to be transmitted to multiple time synchronization followers, and the scheduler circuitry is to manage transmission of the time synchronization messages an interleaved time schedule such that the time synchronization messages to be transmitted to different ones of the time synchronization followers are transmitted at different times.

Moreover, in accordance with an embodiment of the present disclosure the scheduler circuitry is included in a hardware accelerator.

Further in accordance with an embodiment of the present disclosure the network device includes an application-specific integrated circuit (ASIC), which includes the scheduler circuitry.

Still further in accordance with an embodiment of the present disclosure the scheduler circuitry includes a hardware accelerator and/or a microcontroller to run firmware.

There is also provided in accordance with another embodiment of the present disclosure, a method, including receiving time synchronization messages generated by software executed by a processing unit of a host device, maintaining a clock time, managing periodic transmission of the time synchronization messages the clock time and schedule data provided by the software, and transmitting the time synchronization messages to at least one clock synchronization follower the schedule data and the clock time.

Additionally in accordance with an embodiment of the present disclosure the managing includes managing the periodic transmission of the time synchronization messages a transmission time of a first one of the time synchronization messages provided by the software and a given periodic time or frequency provided by the software.

Moreover, in accordance with an embodiment of the present disclosure the time synchronization messages are sync messages Precision Time Protocol (PTP).

Further in accordance with an embodiment of the present disclosure the managing includes managing transmission of each of the time synchronization messages a scheduled transmission time assigned by the software for each of the time synchronization messages.

Still further in accordance with an embodiment of the present disclosure, the method includes executing the software to generate the time synchronization messages and associated work descriptors having corresponding transmission times at which the time synchronization packets are to be transmitted to the at least one clock synchronization follower, wherein the managing includes managing the periodic transmission of the time synchronization messages the corresponding transmission times of the associated work descriptors and the clock time.

Additionally in accordance with an embodiment of the present disclosure the managing includes managing the periodic transmission of the time synchronization messages a given periodic time or frequency provided by the software.

Moreover, in accordance with an embodiment of the present disclosure, the method includes generating by the software the time synchronization messages and associated work descriptors, adding by the software the work descriptors to a work queue designated for transmitting the time synchronization messages, and providing the given periodic time or frequency.

Further in accordance with an embodiment of the present disclosure the time synchronization messages are to be transmitted to multiple time synchronization followers, and the managing includes managing transmission of the time synchronization messages an interleaved time schedule such that the time synchronization messages to be transmitted to different ones of the time synchronization followers are transmitted at different times.

Still further in accordance with an embodiment of the present disclosure the managing is performed by a hardware accelerator.

### BRIEF DESCRIPTION OF THE DRAWINGS

The present disclosure will be understood from the following detailed description, taken in conjunction with the drawings in which:

FIG. 1 is a block diagram view of a clock synchronization system constructed and operative in accordance with an embodiment of the present disclosure;

FIG. 2 is a flow diagram illustrating a flow a time synchronization messages in the system of FIG. 1;

FIG. 3 is a flowchart including steps in a method of operation of a network device in the system of FIG. 1;

FIG. 4 is a schematic view illustrating a first time-synchronization message scheduling method in the system of FIG. 1;

FIG. 5 is a flowchart including steps in a method performed by software in the system of FIG. 1 according to the first time-synchronization message scheduling method of FIG. 4;

FIG. 6 is a flowchart including steps in a method performed by scheduler circuitry in the system of FIG. 1 according to the first time-synchronization message scheduling method of FIG. 4;

FIG. 7 is a schematic view illustrating a second time-synchronization message scheduling method in the system of FIG. 1;

FIG. 8 is a flowchart including steps in a method performed by software in the system of FIG. 1 according to the second time-synchronization message scheduling method of FIG. 7;

FIG. 9 is a flowchart including steps in a method performed by scheduler circuitry in the system of FIG. 1 according to the second time-synchronization message scheduling method of FIG. 7; and

FIG. 10 is a schematic view illustrating time interleaved scheduling in the system of FIG. 1.

### DESCRIPTION OF EXAMPLE EMBODIMENTS

### Overview

As previously mentioned, clock synchronization followers may adjust their clocks based on an estimate of when the next clock synchronization handshake will occur. As the synchronization performance is dependent upon the next time a sync message is received it is important for the leader to try to send the sync messages according to a schedule.

The control process of a synchronization leader or boundary clock synchronization element is usually implemented in a higher layer of the computing stack, such as a software application. A boundary clock is a synchronization element which receives its synchronization solution from an external source and spreads the clock value to other destinations. The boundary clock serves both as a synchronization follower and a leader at the same time. An example of synchronization boundary clock would be a network switch. Let's assume the network switch is connected to a Precision Time Protocol (PTP) grand master and 10 compute nodes. The PTP grand master will be the synchronization leader of the switch, and the switch could serve as a synchronization leader to the 10 compute nodes.

On each synchronization handshake, the follower could adjust its time to the correct one, according to the time on the leader T1 and the calculated delay, and then let the clock run according to its local frequency. Such a solution may result in a suboptimal behavior if the leader and the follower run with different local oscillators, which is usually the case. In this case, the follower will start accumulating an error after each synchronization handshake. The error will exhibit a sawtooth behavior over time.

The error would return to zero after each synchronization handshake, and then the error will start accumulating due to frequency differences. The slope of the graph, which represents the error accumulation rate, would be determined by the frequency difference between the leader and the follower. For example, if frequencies differ by 100 Parts Per Million (PPM) from each other, every second will result in the accumulation of 100 microseconds of error.

Modern synchronization control systems change the local frequency of the clock in order to better fit the leader clock over time. Since the actual frequency and the frequency difference between the systems always changes, for example due to oscillator aging and temperature variations, a control system would continuously run in order to proactively minimize the drift.

As described above, the controller of the follower tries to track the leader, and constantly fixes any accumulated error, mainly due to frequency variations. A digital controller is generally used on the follower side, which wakes up each time a synchronization handshake occurs, and at the end of the handshake adjusts the frequency according to the latest information available, including the latest error. The local frequency will then be set, and be valid until the next handshake occurs. Modern synchronization systems, such as PTP synchronized systems, usually use between one and a few hundred synchronization handshakes per second.

A digital controller usually assumes that a constant time period passes between each handshake. Since the leader generally initiates the process with the first sync message being sent to the follower, ensuring that a constant time passes between the transmission of each sync massage by the leader will help reduce the uncertainty and jitter of the time passed on the follower side between its clock adjustment iterations eventually resulting in better tracking and synchronization performance, and minimizing the error between leader and follower over time. Synchronization controllers that may benefit from constant time between iterations include Proportional-Derivative controller (PD), Proportional-Integral controller (PI) and Proportional-Integral-Derivative controller (PID), by way of example.

One possible solution is for software to try to transmit the sync messages periodically as the synchronization process on the leader side usually runs on higher layers of the computing stack, such as a software application. However, if the software tries to handle the synchronization of the sync messages on its own, it will have to try wake up at certain times, or constantly run and poll the time until a certain time arrives. Such a software implementation will be jittery, due to the non-real-time nature of software systems. The accuracy may degrade when an unrelated central processor unit (CPU) load exists, and when the CPU enters power saving modes. Additionally, the software is usually only aware of the system clock, which may have an error versus the actual physical clock on the network device, which is the source of time that spreads the to the followers. In the PTP use case, the physical clock is referred to as PTP Hardware Clock (PHC).

An additional source of jitter affecting the transmission time of the sync massages may include the process of the sync messages moving through the different layers of the computing stack. If the synchronization process is implemented in software, then the message would have to move from the software down to the physical layer of the communication fabric, passing through multiple layers in between, such as the application, the operating system, network device driver, possibly CPU to network device communication bus, such as a PCIe bus, different logic elements and buffering mechanisms inside the network device, etc. The process can also be affected by the load on the different buses and shared mechanisms, such as the network port or the PCI bus. Therefore, in a software-based solution the exact transmission times of the sync messages may vary a lot from the schedule leading to poor synchronization performance in the follower as described above.

Therefore, embodiments of the present disclosure address at least some of the above drawbacks by using scheduler circuitry (e.g., in a hardware accelerator or including a hardware accelerator and/or a microprocessor running firmware) in a network device to manage periodic transmission of time synchronization messages (e.g., sync messages) to one or more time synchronization followers according to the clock time of a hardware clock maintained by the network device. For example, if the leader has a single follower and synchronization handshakes occur 8 times per second, the leader may send the first sync message on a round second, and the following sync messages 125 milliseconds apart from each other.

In some embodiments, software running on a host device generates the time synchronization messages (e.g., sync messages) and instructs the network device to transmit the generated time synchronization messages according to a periodic schedule, for example, based on a start time of the first time-synchronization message and a transmission frequency or gap for subsequent messages. In some embodiments, the software provides the transmission time of each time synchronization message, for example, via message metadata, such as a work queue entry (WQE) of each message. The term “WQE” is used by way of example only and may be replaced by any suitable work descriptor. The scheduler circuitry tracks the scheduled transmission times of the time synchronization messages against the clock time of the hardware clock of the network device and manages the transmission process so that the generated time synchronization messages are transmitted by the network device as close as possible to the schedule transmission times.

US 2023/0251899 of Levi, at al., which is hereby incorporated by reference, describes a system for processing WQEs according to predetermined times and may provide a basis for sending time synchronization messages according to a periodic schedule by assigning periodic times to the WQEs of respective time synchronization messages.

In some embodiments, packet pacing may be used to transmit the time synchronization messages according to a periodic schedule. An example of packet pacing for other purposes, e.g., video processing, is described in U.S. Pat. No. 11,277,455 to Levi, et al., which is hereby incorporated by reference herein. Packet pacing allows hardware to “consume” and send packets to the wire at a constant rate, offloading the task from the software.

Packet pacing may be implemented using a rate limiter that is synchronized according to the local hardware clock time and executes workloads at desired times. For example, the rate limited can transmit packets in accordance with a real world or local time to achieve a desired transmittal rate. An example of a rate limiter is described in U.S. patent application Ser. No. 18/107,442 of Levi, et al., entitled “Synchronized Rate Control at Rate Limiter” filed on Feb. 8, 2023, and is incorporated by reference herein.

In some embodiments, the network device may periodically transmit time synchronization messages to multiple followers. The messages may be transmitted at the same time or to different followers at different times in a time interleaved manner. One reason to perform time interleaving is to prevent a burst of packets getting stuck in a switch on the way to the multiple followers. For example, if the leader communicates with 2 followers using 10 sync messages per second, the leader may send the first sync message to the first follower on the round second, and the first sync to the second follower on the round second plus 50 milliseconds, and the remaining sync messages 100 milliseconds apart from each other, for each follower. In the above case, the followers will have an offset relative to each other, from the leaders' perspective. The leader may alternatively provide a “burst” of sync packets every 100 milliseconds, and this should also provide constant gaps between each two sync messages to a follower, as long as the order of followers inside every sync burst remains the same. For example, the sync message of follower 1 is the first inside each burst, and the sync message of follower 2 is the second inside each burst, and so on.

### System Description

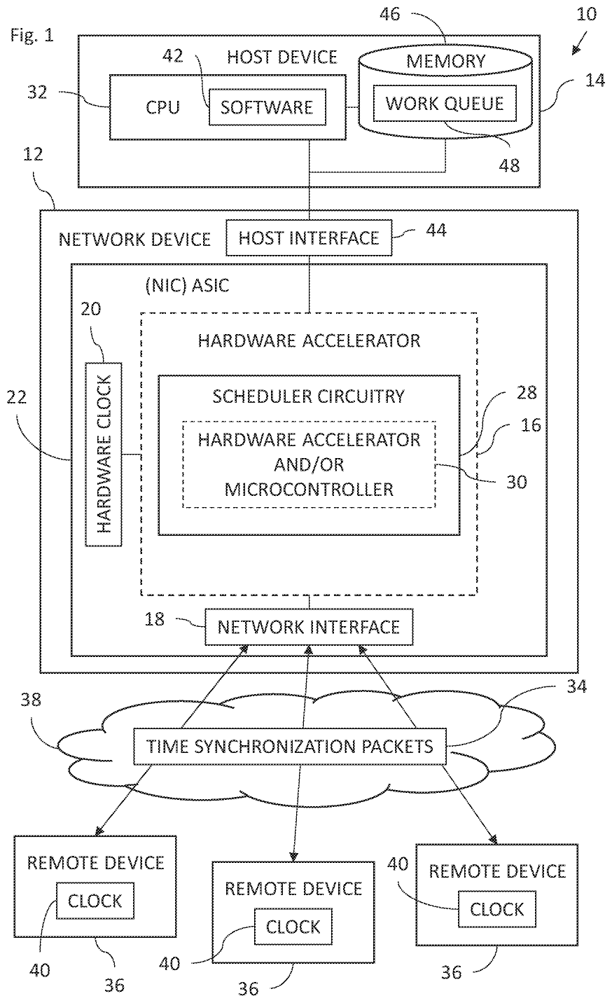

Reference is now made to FIG. 1, which is a block diagram view of a clock synchronization system 10 constructed and operative in accordance with an embodiment of the present disclosure. The clock synchronization system 10 includes a network device 12 (e.g., configured as a clock synchronization leader) and a host device 14 connected to the network device 12 via any suitable peripheral communication data bus operating according to any suitable protocol, for example, Peripheral Component Interconnect Express (PCIe). It should be noted that the network device 12 may be configured, in addition to being a clock leader, as a clock synchronization follower to a leader device such as a clock grandmaster. The host device 14 includes a central processing unit (CPU) 32. The CPU 32 may be configured to execute time synchronization software 42. The host device 14 may also include a memory 46 configured to store a work queue 48.

The network device 12 includes a hardware accelerator 16, a network interface 18, a hardware clock 20, and a host interface 44. The host interface 44 provides a data connection between the network device 12 and host device 14 via the peripheral communication data bus or any suitable connection. The network device 12 may be any suitable network device such as a NIC or a network switch. The network device 12 may include an application-specific integrated circuit (ASIC) 22 such as a NIC ASIC or a switch ASIC. The hardware accelerator 16, network interface 18 and hardware clock 20 may be implemented in the ASIC 22. The network device 12 includes scheduler circuitry 28. In some embodiments, the hardware accelerator 16 includes the scheduler circuitry 28, and may include packet processing circuitry (not shown). In other embodiments, the scheduler circuitry 28 may include a hardware accelerator and/or a microcontroller 30 to run firmware.

The hardware clock 20 is configured to maintain a clock time. The network interface 18 is configured to share time synchronization packets 34 with one or more remote devices 36 (e.g., clock synchronization followers) over a network 38. In some embodiments, time synchronization packets 34 include “sync” messages according to Precision Time Protocol (PTP).

The software 42 is configured to process the time synchronization packets 34 according to a two-way time synchronization protocol (e.g., SPTP, Flash-PTP, PTP-Hybrid, or NTP) in order to cause clock synchronization (time and/or frequency synchronization) between the hardware clock 20 and clock(s) 40 of the remote devices 36. In some embodiments, the software 42 is configured to process the time synchronization packets 34 as a time synchronization leader to synchronize the clock(s) 40 of the remote device(s) 36 to the hardware clock 20. In some embodiments, the software 42 is configured to participate in multiple concurrent time synchronization processes with multiple time synchronization clients (e.g., with the remote devices 36).

In some embodiments, the network device may be configured as a “smart NIC” including a data processing unit (DPU), for example, one or more microprocessors, e.g., ARM® Processors. In some embodiments, the DPU may behave as a host device to the ASIC 22 in which the time synchronization packets 34 are processed by the DPU. In some embodiments, at least some of the processing tasks performed on the time synchronization packets may be performed by software or firmware running on a processor in the network device.

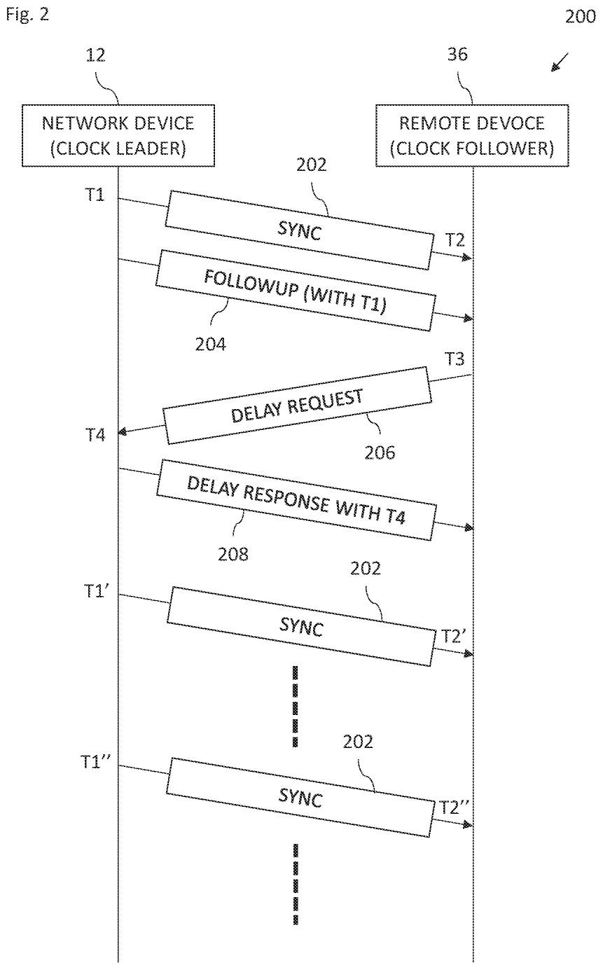

Reference is now made to FIG. 2, which is a flow diagram 200 illustrating a flow of time synchronization messages in the system 10 of FIG. 1. In the example of FIG. 2, the time synchronization packets include sync messages 202, follow up messages 204, delay request messages 206, and delay response messages 208.

The network device 12 sends a first time-synchronization message 202 (e.g., sync message) at time T1 to one of the remote devices 36. The first time-synchronization message 202 is received by remote device 36 at time T2. In response to receiving first time-synchronization message 202, the remote device 36 generates a second time-synchronization message 206 (e.g., a delay request message) and sends the second time-synchronization message 206 to the network device 12 at time T3. The second time-synchronization message 206 is received by network device 12 at time T4. The network device 12 also sends to remote device 36 a third time-synchronization message 204 (e.g., a follow up message including T1) after sending first time-synchronization message 202. The network device 12 also sends, in response to receiving second time-synchronization message 206, a fourth time-synchronization message 208 (e.g., a delay response message including T4) to network device 12. The remote devices 36 may then compute a time adjustment to its clock based on times T1 to T4.

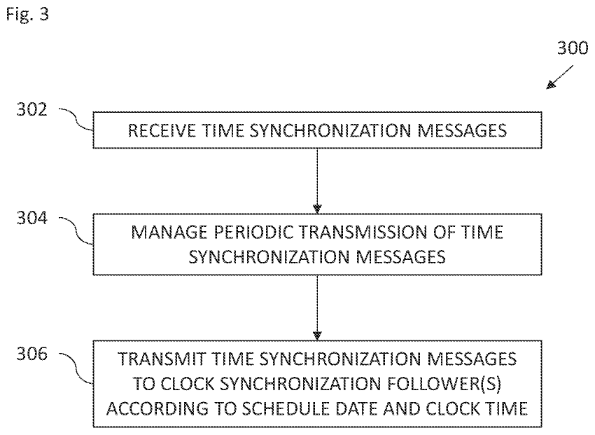

The above handshake is repeated with the sync messages 202 being sent periodically by the network device 12 to the remote devices 36 as described in more detail with reference to FIGS. 3-9 below. FIG. 2 shows that the second sync message 202 is sent at time t′, and the third sync message 202 is sent at time t″.

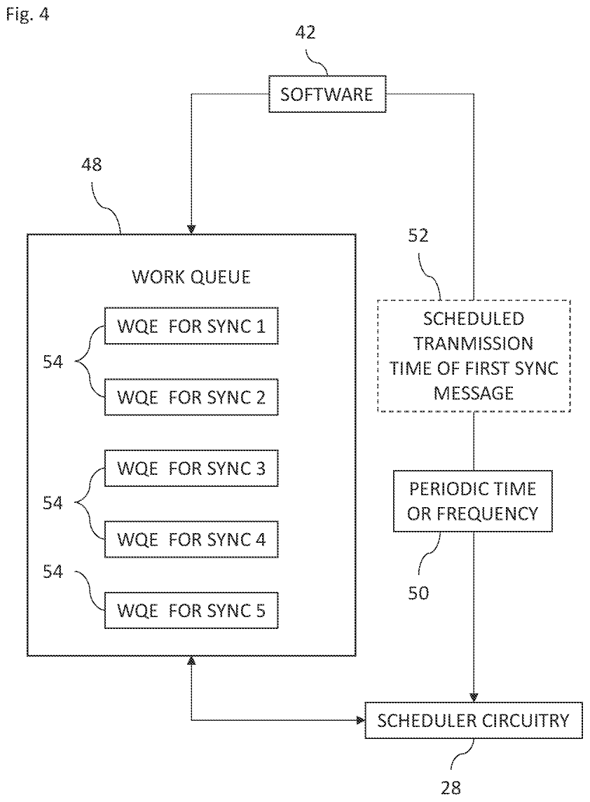

Reference is now made to FIG. 3, which is a flowchart 300 including steps in a method of operation of a network device in the system 10 of FIG. 1. The host interface 44 is configured to receive time synchronization messages 202 (e.g., sync messages) generated by software 42 (block 302). The scheduler circuitry 28 is configured to manage periodic transmission of the time synchronization messages 202 according to the clock time (maintained by the hardware clock 20) and schedule data provided by the software 42 (block 304), as described in more detail with reference to FIGS. 4-10. The network interface 18 is configured to transmit the time synchronization messages 202 to at least one clock synchronization follower (e.g., remote device(s) 36) according to the schedule data and the clock time.

Reference is now made to FIGS. 4 and 5. FIG. 4 is a schematic view illustrating a first time-synchronization message scheduling method in the system 10 of FIG. 1. FIG. 5 is a flowchart 500 including steps in a method performed by software 42 in the system 10 of FIG. 1 according to the first time-synchronization message scheduling method of FIG. 4. The software 42 is configured to provide a given periodic time or frequency 50, and optionally a transmission time 52 of a first one of the time synchronization messages 202, to the scheduling circuitry 28 (block 502). The periodic time may indicate the gap between successive sync messages 202 or a time schedule (e.g., it may indicate that the next sync message 202 should be transmitted on the 10^{th} of a second, and so on with the sync messages 202 after that sync messages 202 (i.e., on the following 10^{th} of a second)). The frequency 50 may indicate the number of sync messages 202 to be sent in a given time period, e.g., 10 messages per second.

The software 42 is configured to generate the time synchronization messages 202 and associated work queue elements (WQEs) 54 or equivalent message metadata, and add the WQEs 54 to work queue 48 designated for (e.g., uniquely) transmitting the time synchronization messages 202 (block 504). When the work queue 48 is designated uniquely for sending sync messages 202, the scheduler circuitry 28 may assume that all the WQEs 54 in the work queue 48 are for the sync messages 202 and therefore the messages associated with the WQEs 54 in the work queue 48 should be transmitted periodically according to the periodic time or frequency 50. FIG. 4 shows five WQEs 54 in the work queue 48 associated with sync messages 1 to 5, respectively, for sending at successive times given by the periodic time or frequency 50 and optionally the transmission time 52.

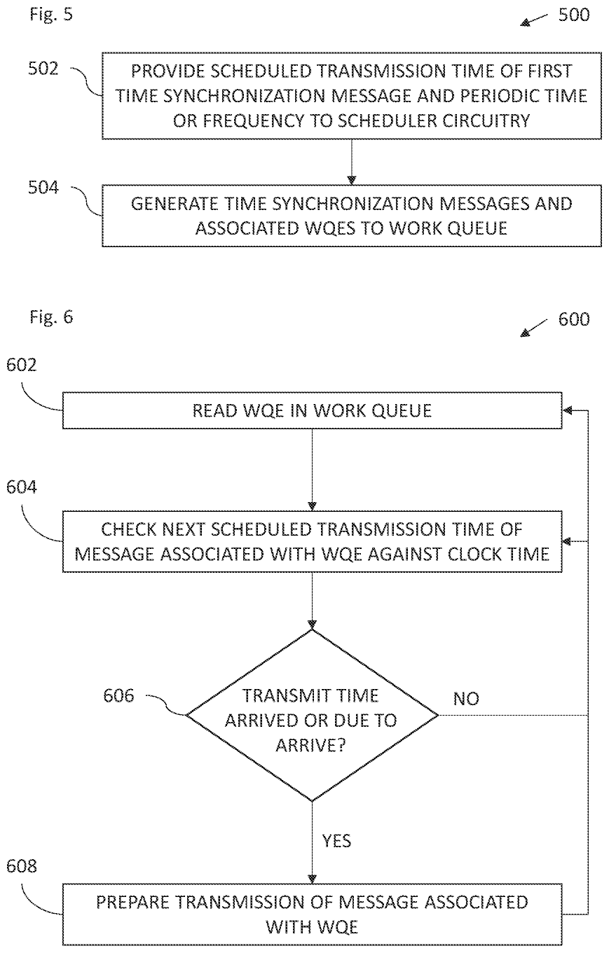

Reference is now made to FIG. 6, which is a flowchart 600 including steps in a method performed by scheduler circuitry 28 in the system 10 of FIG. 1 according to the first time-synchronization message scheduling method of FIG. 4. Reference is also made to FIG. 4. The scheduler circuitry 28 is configured to manage the periodic transmission of the time synchronization messages 202 according to periodic time or frequency 50 provided by the software 42. In some embodiments, the scheduler circuitry 28 is configured to manage the periodic transmission of the time synchronization messages 202 according to the transmission time 52 of the initial time synchronization message 202 (where the transmission time 52 is provided by the software 42) and the given periodic time or frequency 50 provided by the software 42. The scheduler circuitry 28 is configured to read the WQE 54 at the head of the work queue 48 (block 602), and check the next scheduled transmission time of the sync message 202 associated with the read WQE 54 (the next scheduled transmission time may be determined by the periodic time or frequency 50 and optionally the transmission time 52 and optionally the transmission time of the sync message 202 sent most recently) against the clock time maintained by the hardware clock 20 (block 604). At a decision block 606, the scheduler circuitry 28 is configured to determine if the transmission time has arrived or is “due” to arrive (e.g., by considering the processing time needed to process the sync message 202 for transmission). If the transmission time has not arrived or is not “due” to arrive, the step of block 604 is repeated, e.g., periodically. If the transmission time has arrived or is “due” to arrive, the scheduler circuitry 28 is configured to prepare transmission of the sync message 202 associated with the read WQE 54, for example, by passing the sync message 202 and/or the WQE 54 to packet processing circuitry and/or the network interface 18 to perform the process of transmission of the sync message 202 (block 608).

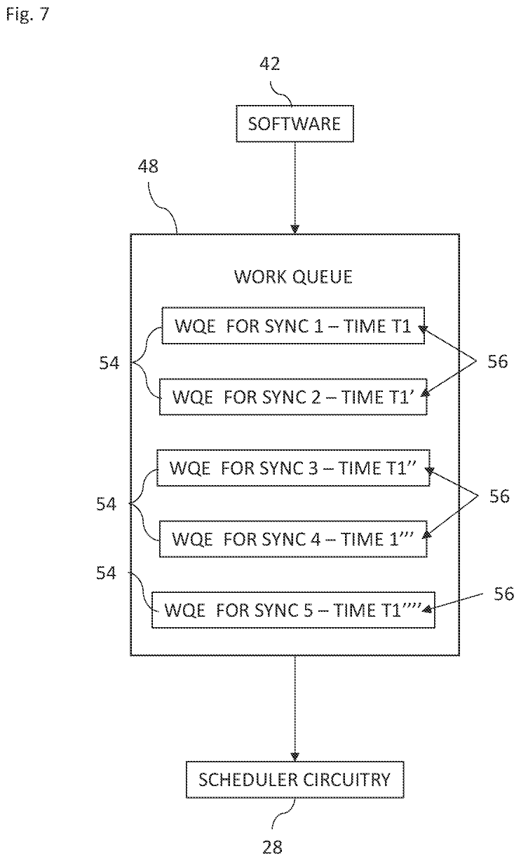

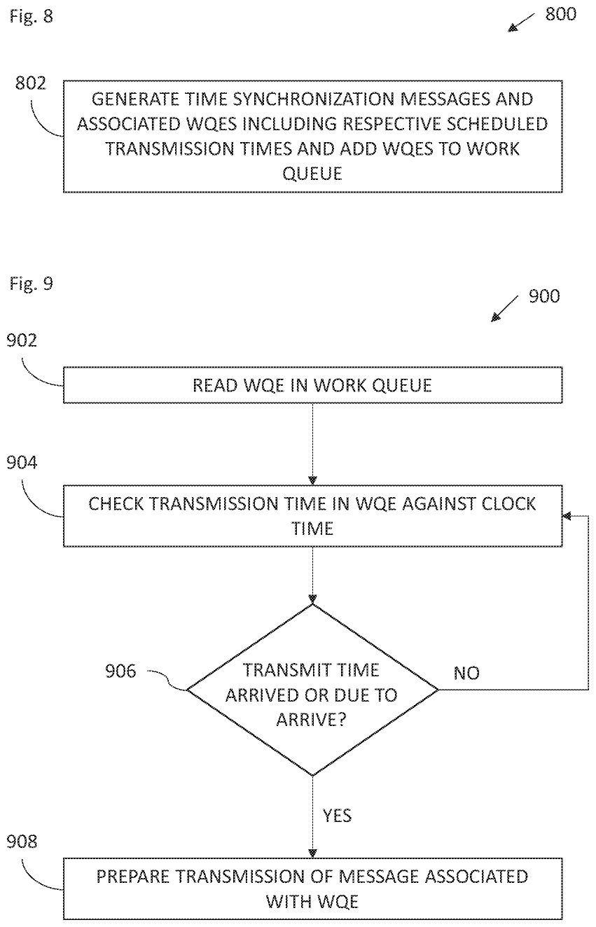

Reference is now made to FIGS. 7 and 8. FIG. 7 is a schematic view illustrating a second time-synchronization message scheduling method in the system 20 of FIG. 1. FIG. 8 is a flowchart 800 including steps in a method performed by software 42 in the system 10 of FIG. 1 according to the second time-synchronization message scheduling method of FIG. 7. The software 42 is configured to generate time synchronization messages 202 and associated work queue elements (WQEs) 54 having corresponding transmission times 56 at which the time synchronization packets 202 are to be transmitted to the clock synchronization follower(s) (e.g., the remote device(s) 36) and add the WQEs 54 to the work queue 48 (block 802). FIG. 7 shows that each of the WQEs 54 has the associated transmission time 56. For example, the WQE 54 for sync message 1 includes the associated transmission of T1, the WQE 54 for sync message 2 includes the associated transmission of T′, and so on.

Reference is now made to FIG. 9, which is a flowchart 900 including steps in a method performed by scheduler circuitry 28 in the system 10 of FIG. 1 according to the second time-synchronization message scheduling method of FIG. 7. Reference is also made to FIG. 7. The scheduler circuitry 28 is configured to manage transmission of each synchronization message 202 according to a scheduled transmission time assigned by the software 42 for each time synchronization message 202. In some embodiments, the scheduler circuitry 28 is configured to manage the periodic transmission of the time synchronization messages 202 according to the corresponding transmission times 56 of the associated WQEs 54 and the clock time maintained by the hardware clock 20.

The scheduler circuitry 28 is configured to read the WQE 54 at the head of the work queue 48 (block 902), and check the scheduled transmission time 56 of the read WQE 54 against the clock time maintained by the hardware clock 20 (block 904). At a decision block 906, the scheduler circuitry 28 is configured to determine if the transmission time 56 has arrived or is “due” to arrive (e.g., by considering the processing time needed to process the sync message 202 for transmission). If the transmission time has not arrived or is not “due” to arrive, the step of block 904 is repeated, e.g., periodically. If the transmission time has arrived or is “due” to arrive, the scheduler circuitry 28 is configured to prepare transmission of the sync message 202 associated with the read WQE 54, for example, by passing the sync message 202 and/or the WQE 54 to packet processing circuitry and/or the network interface 18 to perform the process of transmission of the sync message 202 (block 908).

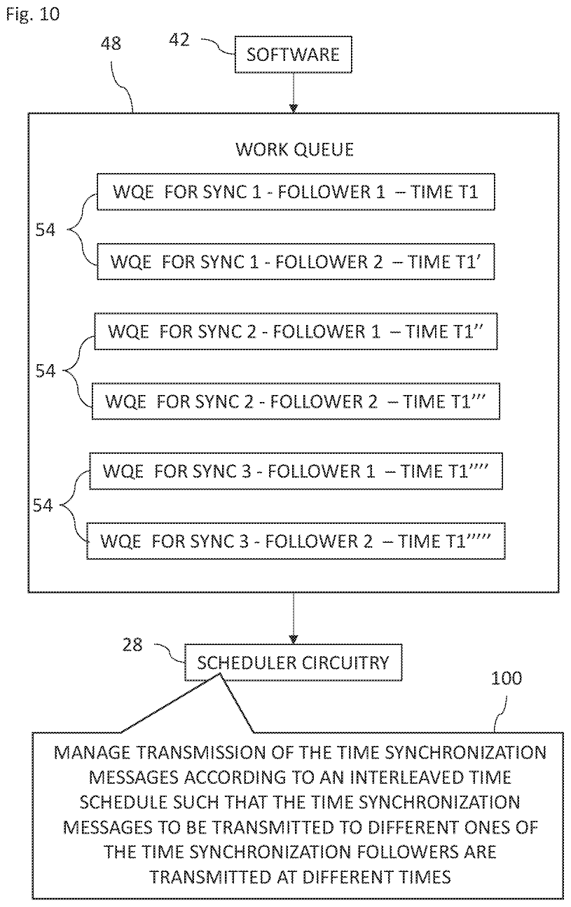

Reference is now made to FIG. 10, which is a schematic view illustrating time interleaved scheduling in the system 10 of FIG. 1. The scheduler circuitry 28 may be configured to manage transmission of time synchronization messages 202 to be transmitted to multiple time synchronization followers, e.g., remote devices 36. In some embodiments, the scheduler circuitry 28 is configured to manage transmission of the time synchronization messages 202 according to an interleaved time schedule such that the time synchronization messages 202 to be transmitted to different ones of the time synchronization followers (e.g., remote devices 36) are transmitted at different times (block 100). In some embodiments, the software 42 is configured to generate WQEs 54 for different sync messages 202 for different remote devices 36 and write the WQEs 54 to the work queue 48 and the scheduler circuitry 28 is configured to manage transmission of the sync messages 202 associated with the WQEs 54 based on the times included in the WQEs 54. FIG. 10 shows a WQE for sync message 1 for follower 1 to be transmitted at time T1, a WQE for sync message 1 for follower 2 to be transmitted at time T1′, and WQE for sync message 2 for follower 1 to be transmitted at time T1″, and so on.

In practice, some or all of the functions of the scheduler circuitry 28 may be combined in a single physical component or, alternatively, implemented using multiple physical components. These physical components may comprise hard-wired or programmable devices, or a combination of the two. In some embodiments, at least some of the functions of the scheduler circuitry 28 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system comprising a network device, the network device including:
a host interface to receive time synchronization messages generated by software executed by a processing unit of a host device;
a hardware clock to maintain a clock time;
scheduler circuitry to manage periodic transmission of the time synchronization messages according to the clock time and schedule data provided by the software; and
a network interface to transmit the time synchronization messages to at least one clock synchronization follower according to the schedule data and the clock time.

2. The system according to claim 1, wherein the scheduler circuitry is to manage the periodic transmission of the time synchronization messages according to a transmission time of a first one of the time synchronization messages provided by the software and a given periodic time or frequency provided by the software.

3. The system according to claim 1, wherein the time synchronization messages are sync messages according to Precision Time Protocol (PTP).

4. The system according to claim 1, wherein the scheduler circuitry is to manage transmission of each of the time synchronization messages according to a scheduled transmission time assigned by the software for each of the time synchronization messages.

5. The system according to claim 4, further comprising the host device including the processing unit to execute the software to generate the time synchronization messages and associated work descriptors having corresponding transmission times at which the time synchronization packets are to be transmitted to the at least one clock synchronization follower, wherein the scheduler circuitry is to manage the periodic transmission of the time synchronization messages according to the corresponding transmission times of the associated work descriptors and the clock time of the hardware clock.

6. The system according to claim 1, wherein the scheduler circuitry is to manage the periodic transmission of the time synchronization messages according to a given periodic time or frequency provided by the software.

7. The system according to claim 6, further comprising the host device including the processing unit to execute the software to:
generate the time synchronization messages and associated work descriptors;
add the work descriptors to a work queue designated for transmitting the time synchronization messages; and
provide the given periodic time or frequency to the scheduling circuitry.

8. The system according to claim 1, wherein:
the time synchronization messages are to be transmitted to multiple time synchronization followers; and
the scheduler circuitry is to manage transmission of the time synchronization messages according to an interleaved time schedule such that the time synchronization messages to be transmitted to different ones of the time synchronization followers are transmitted at different times.

9. The system according to claim 1, wherein the scheduler circuitry is comprised in a hardware accelerator.

10. The system according to claim 1, wherein the network device includes an application-specific integrated circuit (ASIC), which includes the scheduler circuitry.

11. The system according to claim 10, wherein the scheduler circuitry includes a hardware accelerator and/or a microcontroller to run firmware.

12. A method, comprising:
receiving time synchronization messages generated by software executed by a processing unit of a host device;
maintaining a clock time;
managing periodic transmission of the time synchronization messages according to the clock time and schedule data provided by the software; and
transmitting the time synchronization messages to at least one clock synchronization follower according to the schedule data and the clock time.

13. The method according to claim 12, wherein the managing includes managing the periodic transmission of the time synchronization messages according to a transmission time of a first one of the time synchronization messages provided by the software and a given periodic time or frequency provided by the software.

14. The method according to claim 12, wherein the time synchronization messages are sync messages according to Precision Time Protocol (PTP).

15. The method according to claim 12, wherein the managing includes managing transmission of each of the time synchronization messages according to a scheduled transmission time assigned by the software for each of the time synchronization messages.

16. The method according to claim 15, further comprising executing the software to generate the time synchronization messages and associated work descriptors having corresponding transmission times at which the time synchronization packets are to be transmitted to the at least one clock synchronization follower, wherein the managing includes managing the periodic transmission of the time synchronization messages according to the corresponding transmission times of the associated work descriptors and the clock time.

17. The method according to claim 12, wherein the managing includes managing the periodic transmission of the time synchronization messages according to a given periodic time or frequency provided by the software.

18. The method according to claim 17, further comprising:
generating by the software the time synchronization messages and associated work descriptors;
adding by the software the work descriptors to a work queue designated for transmitting the time synchronization messages; and
providing the given periodic time or frequency.

19. The method according to claim 12, wherein:
the time synchronization messages are to be transmitted to multiple time synchronization followers; and
the managing includes managing transmission of the time synchronization messages according to an interleaved time schedule such that the time synchronization messages to be transmitted to different ones of the time synchronization followers are transmitted at different times.

20. The method according to claim 12, wherein the managing is performed by a hardware accelerator.
